(19) United States
(12) Patent Application Publication
(10) Pub. No.: US 2024/0158617 A1
(43) Pub. Date: May 16, 2024

(54) Copolyether-Ester Resin Composition With Improved Hydrolysis Resistance And Heat Stability

(71) Applicant: DuPont Polymers, Inc., Wilmington, DE (US)

(72) Inventors: Yanyan Cao, Wilmington, DE (US); Edward Maxwell De Brant Smith, Wilmington, DE (US); Berardino D'achille, Wilmington, DE (US); Lynda Johnson, Wilmington, DE (US)

(21) Appl. No.: 18/498,319

(22) Filed: Oct. 31, 2023

Related U.S. Application Data
(60) Provisional application No. 63/420,903, filed on Oct. 31, 2022.

(51) Int. Cl. C08K 13/02; C08G 63/183

(52) U.S. Cl. CPC C08K 13/02; C08G 63/183; C08K 2201/019

(57) ABSTRACT

The present disclosure is directed to a copolyether-ester resin composition comprising: a) a copolyether-ester; b) a flame retardant; c) a phosphorus-containing antioxidant; d) an epoxy compound or a reaction product thereof; e) a metal deactivator; and f) an acid scavenger. The present disclosure is also directed to a cable formed from the copolyether-ester resin composition.

### CROSS-REFERENCE TO RELATED APPLICATION

This application claims priority to and the benefit of U.S. Provisional Patent Application No. 63/420,903 filed on Oct. 31, 2022, which is incorporated by reference in its entirety.

### BACKGROUND

Due to excellent mechanical properties (e.g., tear strength, tensile strength, flex life, and abrasion resistance), polymeric compositions based on copolyether-ester elastomers have been used in forming components for motorized vehicles and electronic devices. However, oftentimes, electric arcs may form and high temperatures may be reached within the under-hood areas of vehicles and inside electronic devices.

Thus, while maintaining other mechanical properties, it is desirable that such copolyether-ester-based compositions have low flammability and high thermal stability. Various flame retardant systems have been developed and used in polymeric materials, e.g., polyesters, to improve fire-resistance, while antioxidants have been developed and used to improve heat stability. Nevertheless, as operating temperatures and performance requirements increase, there is a growing need for copolyether-ester compositions having improved retention of mechanical properties on prolonged heat exposure. In addition, stabilizing packages are needed that do not result in blooming or degradation under operating conditions. For example, dilauryl thiodiopropionate (DLTDP) and other thioester stabilizers are subject to blooming and decomposition via hydrolysis. The stabilizers should be effective at low amounts so as to retain the elasticity of the copolyether-ester elastomer, thus maintaining elasticity and limiting brittleness and cracking under operating conditions.

### SUMMARY

In accordance with one embodiment of the present disclosure, a copolyether-ester resin composition is disclosed. The copolyether-ester resin composition comprises: a) a copolyether-ester; b) a flame retardant; c) a phosphorus-containing antioxidant; d) an epoxy compound or a reaction product thereof; e) a metal deactivator; and f) an acid scavenger.

In accordance with another embodiment, a cable is disclosed. The cable is made from the aforementioned copolyether-ester resin composition.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a copolyether-ester composition including a plurality of additives. For instance, in addition to the copolyether-ester, the composition includes a flame retardant, a phosphorus-containing antioxidant, an epoxy compound or a reaction product thereof, a metal deactivator, and an acid scavenger. The present inventors have discovered that such a composition can exhibit the desired mechanical properties, in particular after prolonged heat exposure. In addition, the composition may retain excellent heat and hydrolysis resistance.

For instance, the composition may exhibit a desired thermal or heat stability as determined in accordance with an accelerated air over aging test as defined within the examples. Utilizing such a test, the composition may exhibit an earliest failing time of at least 200 hours, such as at least 220 hours, such as at least 240 hours, such as at least 260 hours, such as at least 280 hours, such as at least 300 hours, such as at least 320 hours, such as at least 340 hours, such as at least 360 hours, such as at least 380 hours, such as at least 400 hours, such as at least 420 hours, such as at least 440 hours.

In addition, the composition may exhibit a desired hydrolysis resistance as determined in accordance with a pressure cook test as defined within the examples. Utilizing such a test, the composition may exhibit an earliest failing time of at least 100 hours, such as at least 120 hours, such as at least 140 hours, such as at least 160 hours, such as at least 180 hours, such as at least 200 hours, such as at least 220 hours, such as at least 240 hours, such as at least 260 hours, such as at least 280 hours.

Copolyether-Ester

Suitable copolyether-esters have a multiplicity of recurring long-chain ester units and short-chain ester units joined head-to-tail through ester linkages, the long-chain ester units being represented by formula (A):

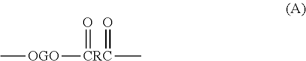

and said short-chain ester units being represented by formula (B):

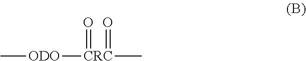

wherein
G is a divalent radical remaining after the removal of terminal hydroxyl groups from poly(alkylene oxide)glycols having a number average molecular weight of between about 400 and about 6000 Da, preferably between about 400 and about 3000 Da, even more preferably between about 600 and about 3000 Da;
R is a divalent radical remaining after removal of carboxyl groups from a dicarboxylic acid having a molecular weight of less than about 300 Da;
D is a divalent radical remaining after removal of hydroxyl groups from a diol having a molecular weight less than about 250 Da.

The term “about” as used here and elsewhere in this application refers to the stated numerical unit ±10%.

The term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000 Da, preferably from about 600 to about 3000 Da, even more preferably between about 600 and about 3000 Da, even more preferably between about 1000 to about 3000 Da, even more preferably between 1000 to about 2000 Da. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol, poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. Mixtures of two or more of these glycols can be used. Long chain ester units of Formula (A) may also be referred to as “soft segments” of a copolyether-ester polymer.

The term “short-chain ester units” as applied to units in a polymer chain of the copolyether-esters refers to low molecular weight compounds or polymer chain units having molecular weights less than about 550 Da, such as less than about 525 Da, such as less than about 500 Da, such as less than about 475 Da, such as less than about 450 Da. They are made by reacting a low molecular weight diol or a mixture of diols (molecular weight below about 250 Da, such as below about 225 Da, such as below about 200 Da, such as below about 175 Da, such as below about 150 Da) with a dicarboxylic acid to form ester units represented by Formula (B) above. Short chain ester units of Formula (B) may also be referred to as “hard segments” of the copolyether-ester polymer.

Included among the low molecular weight diols which react to form short-chain ester units for preparing copolyesters are acyclic, alicyclic and aromatic dihydroxy compounds. Low molecular weight diols which react to form short-chain ester units include aliphatic diols containing 2 to 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol). The term “diols” includes equivalent ester-forming derivatives such as those mentioned. For example, ethylene oxide or ethylene carbonate can be used in place of ethylene glycol. The molecular weights refer to the diols, not to the ester-forming derivatives.

Dicarboxylic acids that can react with long-chain glycols and low molecular weight diols to produce the copolyether-esters are aliphatic, cycloaliphatic or aromatic dicarboxylic acids of a low molecular weight (e.g., having a molecular weight of less than about 300 Da, such as less than about 275 Da, such as less than about 250 Da, such as less than about 225 Da). The term “dicarboxylic acids” includes functional equivalents of dicarboxylic acids that have two carboxyl functional groups that perform substantially similarly to dicarboxylic acids in reaction with glycols and diols in forming copolyether-ester polymers. These equivalents include esters and ester-forming derivatives such as acid halides and anhydrides. The molecular weight in this context pertains to the acid and not to its equivalent ester or ester-forming derivative. Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights.

Aliphatic dicarboxylic acids refer to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

Aromatic dicarboxylic acids can be used. The term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Suitable aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Suitable aromatic dicarboxylic acids include phthalic, terephthalic and isophthalic acids; dibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C1-C12 alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used. Aromatic acids with 8 to 16 carbon atoms are suitable, including terephthalic acid, isophthalic acid, and mixtures of phthalic acid and isophthalic acid.

In one embodiment, an aromatic dicarboxylic acid is preferred for preparing the copolyether-ester. Among the aromatic dicarboxylic acids, those with 8 to 16 carbon atoms, such as 8 to 12 carbon atoms, such as 8 to 10 caron atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyether-ester, isophthalic acid may be a preferred second dicarboxylic acid in one embodiment. For instance, isophthalic acid may be provided in a mixture with terephthalic acid. In this regard, the amount of copolymerized isophthalate residues in the copolyether-ester may be less than 35 mole %, such as less than 30 mole %, such as less than 25 mole %. Similarly, copolymerized isophthalate residues in the copolyether-ester may be less than 35 wt. %, such as less than 30 wt. %, such as less than 25 wt. %, based on the total weight of copolymerized dicarboxylic acid residues —(—C(O)RC(O)—)—in the copolyether-ester. The remainder of the phenylene diradicals may be derived from terephthalic acid based on the total number of moles of copolymerized dicarboxylic acid residues —(—C(O)RC(O)—)— in the copolyether-ester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyether-ester may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred copolyether-esters may include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the copolyether-esters may be prepared from esters or mixtures of esters of terephthalic acid or isophthalic acid, 1,4-butanediol and poly(tetramethylene ether)glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the copolyether-esters may be prepared from esters of terephthalic acid (e.g., dimethylterephthalate), 1,4-butanediol and poly(tetramethylene ether)glycol.

For instance, in one particular embodiment, the copolyether-ester may have the following formula: −[4GT]ₓ-[BT]_{y}-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the copolyether-ester can be a block copolymer of polybutylene terephthalate and polyether segments and can have a structure as follows:

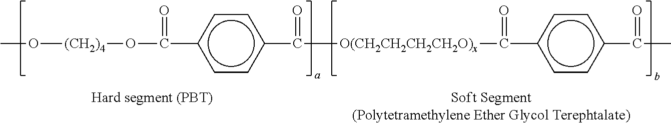

wherein a and b are integers and can vary from 2 to 10,000. The ratio between hard segments and soft segments in the block copolymer as described above can be varied in order to vary the properties of the elastomer.

In general, the copolyether-ester preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The copolyether-ester preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the copolyether-ester preferably comprises about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The copolyether-ester preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the copolyether-ester may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyether-ester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyether-ester may be complementary. That is, the sum of the mole percentages of the R groups in the copolymerized units of Formula (A) and Formula (B) may be 100 mol %.

Furthermore, it should be understood that a mixture of two or more copolyether-esters can be used. In one embodiment, the composition may contain one copolyether-ester as defined herein. In other embodiments, the composition may include a mixture of copolyether-esters. For instance, more than one copolyether-ester, such as two or three copolyether-esters, may be utilized in the composition.

Specifically, regarding the copolyether-esters, in particular a mixture of copolyether-esters, each copolyether-esters used need not on an individual basis come within the values set forth above. In this regard, the mixture of two or more copolyether-esters may conform to the values described herein for the copolyether-esters on a weighted average basis, however. For example, in a mixture that contains equal amounts of two copolyether-esters, one copolyether-ester can contain 60 weight percent short-chain ester units and the other copolyether-ester can contain 30 weight percent short-chain ester units for a weighted average of 45 weight percent short-chain ester units.

Regarding the properties of the copolyether-ester, it may be desired to have a melt flow that can allow it to be processed in a relatively easy manner for the formation of a composition and resulting part/article as disclosed herein. In this regard, the copolyether-ester may exhibit a relatively low melt viscosity as indicated by the melt flow rate. For instance, the melt flow rate of the copolyether-ester may be about 0.5 g/10 min or more, such as about 1 g/10 min or more, such as about 2 g/10 min or more, such as about 3 g/10 min or more, such as about 4 g/10 min or more, such as about 5 g/10 min or more. The melt flow rate may be about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The copolyether-ester may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min.

In addition, the glass transition temperature of the copolyether-ester may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the copolyether-ester may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Further, the copolyether-ester may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The copolyether-ester may have a density of about 2 g/cm³ or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the copolyether-ester utilized may exhibit a certain mechanical strength. In particular, the copolyether-ester may not be as likely to resist deformation in bending compared to other types of materials and as a result, the copolyether-ester may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the copolyether-ester may have a particular Shore D hardness, which can provide an indication of the resistance to indentation of the copolyether-ester. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the copolyether-ester to provide the compliance necessary to effectively function for use in a particular application. The Shore D hardness may be determined in accordance with ISO 868-2003 (15 seconds).

In addition, the copolyether-ester may have other beneficial mechanical properties. For instance, the tensile stress at break may be about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the copolyether-ester may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C.

Suitable copolyether-esters are also described in PCT/US19/49060 (published as WO/2020/047406, which is incorporated into this application by reference for its teaching of copolyether-esters. Specific copolyether-esters are commercially available from DuPont Specialty Products USA, LLC, of Wilmington, DE, under the Hytrel® trademark.

The composition may generally comprise about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more of the copolyether-ester based on the weight of the composition. The composition may comprise less than 100 wt. %, such as about 98 wt. % or less, such as about 95 wt. % or less, such as about 93 wt. % or less, such as about 90 wt. % or less, such as about 87 wt. % or less, such as about 85 wt. % or less, such as about 83 wt. % or less, such as about 80 wt. % or less, such as about 75 wt. % or less of the copolyether-ester based on the weight of the composition.

Flame Retardant

The flame retardant is not particularly limited as long as it imparts flame retardancy to the resin composition and articles made from the composition. Exemplary flame retardants include nitrogen compound-based flame retardants, silicone-based flame retardants, and other inorganic flame retardants. Other examples include brominated flame retardants.

Specific examples of brominated flame retardants include decabromodiphenyl oxide, octabromodiphenyl oxide, tetrabromodiphenyl oxide, tetrabromophthalic anhydride, hexabromocyclododecane, bis (2,4,6-tribromo) phenoxy) ethane, decabromodiphenyl ethane (e.g., a composition of decabromodiphenyl ethane and antimony oxide), ethylenebistetrabromophthalimide, hexabromobenzene, 1,1-sulfonyl [3,5-dibromo-4-(2,3-dibromopropoxy)] benzene, polydibromophenylene oxide, tetrabromobisphenol-S, Tris (2,3-dibromopropyl-1) isocyanurate, tribromophenol, tribromophenyl allyl ether, tribromoneopentyl alcohol, brominated polystyrene, brominated polyethylene, tetrabromobis Enol-A, tetrabromobisphenol-A derivative, tetrabromobisphenol-A-epoxy oligomer or polymer, tetrabromobisphenol-A-carbonate oligomer or polymer, brominated epoxy resin such as brominated phenol novolac epoxy, tetrabromobisphenol-A-Bis (2-hydroxydiethyl ether), tetrabromobisphenol-A-bis (2,3-dibromopropyl ether), tetrabromobisphenol-A-bis (allyl ether), tetrabromocyclooctane, ethylenebispentabromodiphenyl, Tris (tribromoneopentyl) phosphate, poly(pentabromobenzylpolyacrylate), octabromotrimethylphenylindane, dibromoneope Chill glycol, pentabromobenzyl polyacrylate, dibromo cresyl glycidyl ether, N, N′ethylene-bis-such as tetrabromo phthalic imide.

In one example of the resin composition, the flame retardant is a brominated flame retardant such as brominated polystyrene, 1,2-bis(tetrabromophthalimido)ethane, a brominated polyethylene composition that is free of polybromodiphenyloxide (e.g., ENDURA PE-302-1), any of which can be coformulated with a synergist or stabilizer such as antimony oxide or antimony oxide in polyethylene (e.g., prepared from a masterbatch of 80% antimony oxide in polyethylene).

In some examples of the resin composition, the flame retardant is present in the composition in an amount ranging from about 2% to about 20% by weight of the resin composition, e.g., from about 2% to about 10% by weight of the resin composition, from about 4% to about 8% by weight of the resin composition, or from about 5% to about 7% by weight of the resin composition. For instance, the flame retardant may be present in an amount of about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more based on the weight of the resin composition. The flame retardant may be present in an amount of about 20 wt. % or less, such as about 18 wt. % or less, such as about 16 wt. % or less, such as about 14 wt. % or less, such as about 12 wt. % or less, such as about 10 wt. % or less, such as about 8 wt. % or less, such as about 7 wt. % or less, such as about 6 wt. % or less, such as about 5 wt. % or less, such as about 4 wt. % or less based on the weight of the resin composition.

Phosphorus-Containing Antioxidant

The resin composition can include a phosphorus-containing antioxidant. The phosphorus-containing antioxidant can be a phosphite or a phosphonite. Suitable examples include monophosphites, diphosphites and polyphosphites.

Suitable monophosphites include, for example, trialkylphosphites, dialkylaryl phosphites, alkyldiaryl phosphites and triaryl phosphites. The alkyl groups in these phosphites may be linear as well as branched, may comprise cyclic or aromatic groups and may also comprise hetero-atom containing substituents. The aryl groups in these phosphites may be unsubstituted aryl groups as well as substituted aryl groups, wherein the substituted aryl groups may comprise, for example, alkyl groups and/or hetero-atom containing substituents.

In some examples, the phosphorous-containing antioxidant is a diphosphite, a sterically hindered aryl phosphite (e.g., pentaerythritol diphosphite), a hindered amine stabilizer phosphite, a pentaerythritol diphosphite, or any mixture thereof. The order of hydrolysis resistance of phosphites is typically sterically hindered aryl phosphites>unsubstituted aryl phosphites>araliphatic phosphites>aliphatic phosphites. Examples of suitable sterically hindered aryl phosphites and Hindered Amine Stabilizers (HAS) phosphites include those bearing 2,2,6,6-tetramethyl or 1,2,2,6,6-pentamethyl piperidinyl groups.

In one embodiment, the phosphorus-containing antioxidant may be a diphosphate. Suitable diphosphites include biphenylene diphosphites, pentaerythritol diphosphites, 4,4′-iso-propylidenediphenol diphosphites, and dipropyleneglycol diphosphites. The phosphite groups in these diphosphites suitably comprise alkyl or aryl groups, wherein the alkyl and aryl groups suitably are chosen from the alkyl and aryl groups mentioned above for the monophosphites.

An example of a suitable biphenylene diphosphite is tetrakis-(2,4-di-tert-butyl-phenyl)-4,4′-biphenylene diphosphite. Examples of suitable pentaerythritol diphosphites are bis(2,4-di-t-butylphenyl)pentaerythritol diphosphite and bis-(2,4-dicumylphenyl)pentaerythritol diphosphite. An example of a suitable 4,4′-iso-propylidenediphenol diphosphite is tetrakis(iso-decyl) iso-propylidenediphenol diphosphite, and an example of a suitable dipropyleneglycol diphosphite is tetraphenyl dipropyleneglycol diphosphite.

In some examples, the phosphorous-containing antioxidant is tris(2,4-di-tert-butylphenyl) phosphite, 1,3,7,9-tetrate rt-butyl-11-(2-ethylhexoxy)-5h-benzo[d][1,3,2]benzodioxaphosphocine, 3,9-bis(octadecyloxy)-2,4,8,10-tetraoxa-3,9-diphosphaspiro[5.5]undecane, bis(2,4-dicumylphenyl) pentaerythritol diphosphite, tris(nonylphenyl) phosphite, isodecyl diphenyl phosphite, 4,4′-isopropylidenediphenol C12-15 alcohol phosphite, triisodecyl phosphite, 2-ethylhexyl diphenyl phosphite, triphenyl phosphite, diisodecyl phenyl phosphite, bis(2,6-di-ter-butyl-4-methylphenyl)pentaerythritol-di-phosphite, bis(2,4-di-t-butylphenyl)pentaerythritol diphosphite, 2,2′2″-nitrilo[triethyl-tris[3,3′,5,5′-tetra-tert-butyl-1,1′-biphenyl-2,2′-diyl]]phosphite, tetrakis(2,4-di-tert-butylphenyl)[1,1-biphenyl]-4,4′diylbisphosphonite, or any mixture thereof.

In a further example the phosphorous-containing antioxidant is bis(2,4-di-tert-butylphenyl)pentaerythritol diphosphite, bis(2,6-di-tert-butyl-4-methylphenyl)pentaerythritol-di-phosphite, bis (2,4-dicumylphenyl) pentaerythritol diphosphite, bis(2,4-di-t-butylphenyl)pentaerythritol diphosphite, or any mixture thereof.

The phosphorus-containing antioxidant may be a solid phosphite at ambient conditions in one embodiment. In another embodiment, the phosphorus-containing antioxidant may be a liquid phosphite at ambient conditions.

Suitable phosphorus-containing antioxidants including phosphite and phosphonite antioxidants are also described in PCT/US19/49060 (published as WO/2020/047406, which is incorporated into this application by reference for its teaching of phosphorus-containing antioxidants.

In some examples, the resin composition can comprise the phosphorus-containing antioxidant in an amount ranging from about 0.05% to about 2% by weight of the resin composition, e.g., from about 0.1% to about 1% by weight of the resin composition, from about 0.15% to about 0.5% by weight of the resin composition, or from about 0.3% to about 0.4% by weight of the resin composition. For example, the phosphorus-containing antioxidant may be present in an amount of about 0.05 wt. % or more, such as about 0.1 wt. % or more, such as about 0.15 wt. % or more, such as about 0.2 wt. % or more, such as about 0.25 wt. % or more, such as about 0.3 wt. % or more based on the weight of the resin composition. In one embodiment, the phosphorus-containing antioxidant may be present in an amount of about 2 wt. % or less, such as about 1.5 wt. % or less, such as about 1.3 wt. % or less, such as about 1 wt. % or less, such as about 0.8 wt. % or less, such as about 0.6 wt. % or less, such as about 0.55 wt. % or less, such as about 0.5 wt. % or less, such as about 0.45 wt. % or less, such as about 0.4 wt. % or less, such as about 0.35 wt. % or less, such as about 0.3 wt. % or less based on the weight of the resin composition.

Epoxy Compound

The resin composition can comprise an epoxy compound, or a reaction product of an epoxy compound. The term “epoxy compound” encompasses any compound bearing one or more epoxide group functionalities, including polymers having multiple epoxy functionalities, such as copolymers of ethylene/n-butyl acrylate/glycidyl methacrylate. In some examples, the epoxy compound has a maximum of two epoxide groups per molecule.

Suitable epoxy compounds can be made by the reaction of epichlorohydrin with diphenylolpropane, diphenylolmethane, diamines, diacids and diols such as polypropylene glycol, and polymers having glycidyl groups such as ethylene/n-butyl acrylate/glycidyl methacrylate. In some examples, epoxy compounds are made by the reaction of epichlorohydrin with diphenylolpropane, diphenylolmethane or diols such as polypropylene glycol.

Examples of suitable epoxy compounds include poly(bisphenol A-co epichlorohydrin) glycidyl end-capped, poly(bisphenol F-co epichlorohydrin) glycidyl end-capped, tetraglycidyl ethers of tetraphenol ethane, polypropyleneglycol diglycidyl ether copolymers of ethylene/n-butyl acrylate/glycidyl methacrylate, copolymers of ethylene/n-methyl acrylate/glycidyl methacrylate, resorcinol diglycidyl ether, poly(phosphonate-co-carbonate, or any mixture thereof. In one particular embodiment, the epoxy compound may be Phenol, 4,4′-(1-methylethylidene)bis-, polymer with 2,2′-[(I-methylethylidene)bis (4,1-phenyleneoxymethylene)]bis(oxirane). However, it should be understood that other epoxy compounds may also be utilized.

In a further example, the epoxy compound is formulated into the resin based on the amount of epoxide groups desired in the composition. To calculate the amount of epoxide groups in the composition the group —CHOCH₂ is used, which has a molecular weight of 43 g/mol. The epoxide groups from the epoxy compound can be present at 0.01% to 2.00 wt. % by weight of the resin composition, e.g., 0.05 to 1.00 wt. %, or 0.1 to 0.6 wt. %, based on the total weight of the copolyether-ester resin composition.

In some examples, the copolyether-ester composition can comprise the epoxy compound (or a reaction product of an epoxy compound) in an amount ranging from about 0.01% to about 10% by weight of the resin composition, e.g., from about 1% to about 8% by weight of the resin composition, from about 3% to about 8% by weight of the resin composition, from about 4% to about 7% by weight of the resin composition, or from about 5% to about 6% by weight of the resin composition. For example, the epoxy compound (or a reaction product of an epoxy compound) may be present in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 5 wt. % or more based on the weight of the resin composition. The epoxy compound (or a reaction product of an epoxy compound) may be present in an amount of about 10 wt. % or less, such as about 9 wt. % or less, such as about 8 wt. % or less, such as about 7 wt. % or less, such as about 6 wt. % or less, such as about 5 wt. % or less based on the weight of the resin composition.

Other Additives

In some examples, the resin composition can comprise a metal deactivator. The metal deactivator is not limited. Typically, the deactivator is any compound capable of deactivating metal ions often by sequestering metal ions. The metal deactivator can be selected from nitrogen-containing aromatic heterocycles, and aromatic compounds comprising at least one function —NH—C(═O)—, and preferably from aromatic compounds comprising at least one function —NH—C(═O)—. The presence of the oxygen in the metal deactivator is important to durably enable immobilization of metallic ions.

The metal deactivator may be different from a hindered amine. In other words, the metal deactivator may not comprise one or more tetramethylpiperidine groups. Examples of nitrogen-containing aromatic heterocyclics include quinoline derivatives such as polymerized 2,2,4-trimethyl-1,2-dihydroquinolines (TMQs). TMQs can have different grades, namely: (a) a “standard” grade with a low degree of polymerization, i.e. with a residual monomer content greater than 1% by weight and having a residual NaCl content ranging from 100 ppm to more than 800 ppm (parts per million by weight); (b) a “high degree of polymerization” grade with a high degree of polymerization, i.e. with a residual monomer content of less than 1% by weight and having a residual NaCl content ranging from 100 ppm to more than 800 ppm; (c) a “low residual salt content” grade with a residual NaCl content of less than 100 ppm.

Examples of aromatic compounds comprising at least one function —NH—C(═O)— are those comprising two functions —NH—C(═O)—, preferably comprising two functions —NH—C(═O)— covalently linked, and more particularly preferably comprising a divalent group —NH—C(═O)—C(═O)—NH— or —C(═O)—NH—NH—C(═O)—, such as 2,2′ oxamidobis-[ethyl-3-[ethyl-3-(3,5-di-tert-butyl-4-hydroxyphenyl)propionate] (Naugard XL-1), 2′,3-bis[[3-[3,5-di-tert-butyl-4-hydroxyphenyl]propionyl]]propionohydrazide or 1,2-bis(3,5-di-tert-butyl-4-hydroxyhydrocinnamoyl)hydrazine (Irganox® 1024 or Irganox® MD 1024), or oxalyl bis(benzylidenehydrazide) (OABH). In one embodiment, a suitable example is bis(3,5-di-tert-butyl-4-hydroxyhydrocinnamoyl)hydrazine.

In some examples, the metal deactivator can be present in an amount ranging from about 0.01% to about 2% by weight of the resin composition, e.g., from about 0.1% to about 1% by weight of the resin composition, or from about 0.5% to about 1% by weight of the resin composition. For example, the metal deactivator may be present in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more based on the weight of the resin composition. The metal deactivator may be present in an amount of about 2 wt. % or less, such as about 1.5 wt. % or less, such as about 1.3 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less based on the weight of the resin composition.

The resin composition can also include an acid scavenger in some examples. A suitable example is aluminate (Al(OH)63-), (OC-6-11)-, magnesium carbonate hydroxide (2:6:1:4). Acid scavengers may include a carboxylic acid salt. For instance, the acid scavenger may comprise an alkaline earth metal salt of a carboxylic acid such as a calcium hydroxy stearate. The acid scavenger, for instance, may comprise an alkali metal salt or an alkaline earth metal salt. For instance, the acid scavenger may comprise a calcium salt and/or a magnesium salt, such as a citrate or a carbonate. The salt can comprise a salt of a fatty acid, such as a stearate. Other acid scavengers include carbonates, oxides, or hydroxides. Still other acid scavengers include zinc oxide, calcium carbonate, magnesium oxide, and mixtures thereof.

In some examples, the acid scavenger can be present in an amount ranging from about 0.1% to about 1% by weight of the resin composition, e.g., from about 0.1% to about 0.5% by weight of the resin composition, from about 0.1% to about 0.3% by weight of the resin composition, or from about 0.1% to about 0.2% by weight of the resin composition. For example, the acid scavenger may be present in an amount of about 0.01 wt. % or more, such as about 0.05 wt. % or more, such as about 0.1 wt. % or more, such as about 0.15 wt. % or more, such as about 0.2 wt. % or more, such as about 0.25 wt. % or more based on the weight of the resin composition. The acid scavenger may be present in an amount of about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.25 wt. % or less, such as about 0.2 wt. % or less, such as about 0.15 wt. % or less based on the weight of the resin composition.

In some examples, the resin composition is free of thioester antioxidants. One unexpected result of the resin composition is that a thioester antioxidant is not required (see, e.g., Table 1 below). This can be beneficial because thioester antioxidants can bloom and decompose. In one example, the resin composition is free of didodecyl 3,3′-thiodipropionate (DLTDP). In this regard, the resin composition may comprise less than about 0.2 wt. %, such as less than about 0.15 wt. %, such as less than about 0.1 wt. %, such as less than about 0.05 wt. %, such as less than about 0.01 wt. %, such as about 0 wt. % of any thioeseter antioxidants based on the weight of the resin composition.

In other examples, the resin composition can include a thioester antioxidant. Suitable thioester antioxidants are described in PCT/US19/49060 (published as WO/2020/047406, which is incorporated into this application by reference for its teaching of thioester antioxidants. One example of a thioester antioxidant that can be included in some examples is didodecyl 3,3′-thiodipropionate (DLTDP).

Phenolic antioxidants and arylamine antioxidants can also be included in the resin composition in some examples. Suitable phenolic and arylamine antioxidants are described in PCT/US19/49060 (published as WO/2020/047406), which is incorporated into this application by reference for its teaching of phenolic and arylamine antioxidants.

The phenolic antioxidant may be a sterically hindered phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-, S,S-bis(4-tert-butyl-3-hydroxy-2,6-dimethylbenzyl) ester (Cyanox®1729); triethylene glycol bis(3-tert-butyl-4-hydroxy-5-methylhydrocinnamate); hexamethylene bis(3,5-di-tert-butyl-4-hydroxyhydrocinnamate (Irganox®259); 1,2-bis(3,5,di-tert-butyl-4-hydroxyhydrocinnamoyl)hydrazide (Irganox®1024); 4,4′-di-tert-octyldiphenamine (Naugalube®438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox®1330); 2,4-bis(octylthio)-6-(4-hydroxy-3,5-di-tert-butylanilino)-1,3,5-triazine (Irganox®565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox®1520); N,N′-trimethylenebis-[3-(3,5-di-tert-butyl-4-hydroxyphenyl)propionamide (Irganox®1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT) and so forth. In one embodiment, for instance, the phenolic antioxidant comprises pentaerythrityl tetrakis[3-(3,5-di-tert-butyl-4-hydroxyphenyl)propionate]. Suitable phenolic antioxidants include N,N′-propane-1,3-diylbis[3-(3,5-di-tert-butyl-4-hydroxyphenyl)propionamide] and N,N′-hexane-1,6-diylbis[3-(3,5-di-tert-butyl-4-hydroxyphenyl)propanamide].

Suitable arylamine antioxidants include, but are not limited to, 4,4′-bis(alpha, alpha-dimethylbenzyl)diphenylamine, benzenamine, N-phenyl-, reaction products with 2,4,4-trimethylpentene, etc. In one embodiment, the arylamine antioxidant is 4,4′-bis(alpha, alpha-dimethylbenzyl)diphenylamine.

The phenolic or arylamine antioxidants, individually or in combination, can be present in an amount ranging from 0.1 to 2% by weight of the resin composition in some examples. For example, the phenolic or arylamine antioxidants, individually or in combination, can be present in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more based on the weight of the resin composition. The phenolic or arylamine antioxidants, individually or in combination, may be present in an amount of about 2 wt. % or less, such as about 1.5 wt. % or less, such as about 1.3 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less based on the weight of the resin composition.

In addition to the above, the composition may optionally include other additives as generally known in the art. These may include, but are not limited to, compatibilizers, pigments, colorants, dyes, dispersants, other flame retardants, other antioxidants, conductive particles, UV-inhibitors, UV-stabilizers, adhesion promoters, fatty acids, esters, paraffin waxes, neutralizers, tackifiers, dessicants, stabilizers, light stabilizers, light absorbers, coupling agents, plasticizers, lubricants, blocking agents, anti-blocking agents, antistatic agents, waxes, nucleating agents, slip agents, other acid scavengers, lubricants, adjuvants, polymeric additives, preservatives, thickeners, rheology modifiers, humectants, reinforcing and non-reinforcing fillers, and combinations thereof.

Such other additives may be provided in an amount as necessary. For instance, the additive, individually or in combination, may be provided in an amount of about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more, such as about 15 wt. % or more, such as about 20 wt. % or more, such as about 25 wt. % or more based on the weight of the resin composition. The additive, individually or in combination, may be provided in an amount of about 40 wt. % or less, such as about 35 wt. % or less, such as about 30 wt. % or less, such as about 25 wt. % or less, such as about 20 wt. % or less, such as about 18 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.5 wt. % or less, such as about 1.3 wt. % or less, such as about 1 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less based on the weight of the resin composition.

Composition Formation

The composition described herein can be processed using techniques generally known in the art. For instance, the components (copolyether-ester, ethylene acrylic copolymer, ATH, and other optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 150 to 300° C., such as from 200 to 280° C., such as from 220 to 270° C. or 240 to 260° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation or molding apparatus for formation of a resulting molded part or article.

Molded Parts (e.g., Cables Extruded from the Resin Composition)

The composition is suitable for forming molded parts and articles. In this regard, the composition may be molded into a molded part/article using conventional molding apparatuses and techniques, such as injection molding, extrusion molding, compression molding, blow molding, rotational molding, overmolding, thermoforming, etc. In general, these processes may include heating the composition to a temperature that is equal to or in excess of the melt temperature to form a pre-form for a mold cavity to then form the molded part, cooling the molded part to a temperature at or below the crystallization temperature, and releasing the molded part/article from a mold. The mold cavity defines the shape of the molded part/article. The molded part/article is cooled within the mold at a temperature at or below the crystallization temperature and the molded part/article can subsequently be released from the mold. The process may also utilize extrusion molding. In this regard, the composition may be extruded as described herein. Upon exiting the extruder, the composition may be formed or shaped to a desired part/article. Such part/article may be formed by using a particular die to shape the composition as it exits the extruder. Such shaping/forming process, such as the extrusion process, may be an automated or robotic process.

The composition as disclosed herein may be utilized in a variety of applications. For instance, the composition may be suitable for an automotive part, an electronic part, a consumer goods article, a medical article, among others.

One application of the resin composition is for wires or cables, particularly cables in one embodiment. For instance, a wire or a cable may be made, such as by extrusion, from the resin composition. Generally, a wire or cable includes an elongated protective member that defines a passageway for receiving one or more items, such as a conductor, fluid, etc. The elongated protective member may contain multiple layers or a single layer. The wire or cable may be a metal wire (e.g., copper wire), a telephone line, an optical fiber, a telecommunication cable, etc. A cable such as an ultrathin wall automotive cable is one example; however, it should be understood that cables for other applications, such as electronics, medical, etc. may also be made from the resin composition.

It was unexpectedly discovered that wires or cables, particularly cables, extruded from the resin composition can have an outer diameter ranging from about 0.8 mm to about 1.5 mm (e.g., about 0.8 mm or more, such as about 0.9 mm or more, such as about 1 mm or more, such as about 1.1 mm or more to about 1.5 mm or less, such as about 1.4 mm or less, such as about 1.3 mm or less, such as about 1.2 mm or less, such as about 1.1 mm or less) and a wall thickness ranging from about 0.1 mm to about 0.5 mm (e.g., about 0.1 mm or more, such as about 0.2 mm or more, such as about 0.3 mm or more to about 0.5 mm or less, such as about 0.4 mm or less, such as about 0.3 mm or less). In addition, the resin composition and resulting cables may still retain excellent heat and hydrolysis resistance.

### Examples

The following examples further illustrate this disclosure. The scope of the disclosure and claims is not limited by the scope of the following examples.

The base resin was a copolyether-ester with a Shore D hardness (max) of 68 as measured according to ISO 868 with type D durometer. It has hard segments composed of polybutylene terephthalate and soft segments composed of polyether terephthalate. The base resin was stabilized with 0.3 wt. % phenolic antioxidants (1:1 mix of Irganox 1019 and Irganox 1098).

Samples in Table 1 below were compounded in 32 mm or 26 mm Coperion twin screw extruders with length/diameter ratio of 56/1. Barrel temperatures were set at 25-230° C. All materials used are described in Table 2.

The compounds from the twin screw extruder were then extruded into cable form with a cross-head die on a Brabender single screw extruder 0.22 gauge copper wire was used for making cables with 1.2 mm outer diameter.

Heat stability of the cables were evaluated with an accelerated air oven aging (AOA). AOA samples were prepared by cutting cable into strands of 7 inches in length. 25 mm of insulation were removed from each end of each strand. The strands of cables were placed in the air oven set at 155° C. They were fixed by the conductor to avoid any contact between the insulation and the supports. Samples were taken out at designated times (such as 304, 352, 375, 426, 450 hr). A “winding test” was performed at room temperature using a mandrel with a diameter of 6 mm. If no cracks happened, and there was no conductor visible, sample was considered passing. If cracks happened, sample was considered failing. Samples that can pass 375 hr AOA at 155° C. are generally considered having good heat stability for T3 automotive cable application.

Hydrolysis resistance of the materials were evaluated with a pressure cooker test (PCT). PCT samples were prepared by cutting the cable into 1 meter long pieces. 25 mm of insulation were removed from each end. The pieces of cables were wound up and placed in a pressure cooker set at 120° C. Samples were taken out at designated times (such as 120, 148, 216, 264 hr). The winding test was performed at room temperature using a mandrel with a diameter of 6 mm. If no cracks happened, and there was no conductor visible, sample was considered passing. If cracks happened, sample was considered failing.

Comparing E2 and C1, the only difference is that E2 contained Epon 1002F, while C1 did not have Epon 1002F. As shown in Table 1, C1 failed earlier than E2 in both AOA and PCT. Comparing E2 and E3, E2 had DLTDP, while E3 did not. Those two performed similarly in AOA and PCT. Comparing E3 and C2, E3 had Ultranox 626, while C2 did not. AOA performance of C2 is worse than E3. Comparing E3 and C3, E3 had 0.8% Irganox MD1024, while 3 had only 0.4% Irganox MD1024. The reduction in Irganox MD1024 lading led to worse performance in AfA and PCT. Comparing E3 and 04, E3 had DHT-4A, while 04 did not. 04 had both worse AA performance and worse PCT performance than E3. Comparing E3 and E4, taking out Naugard did not change the AOA and PCT performance significantly.

TABLE 1
Sample compositions (in wt. %) and the AOA and PCT performance

| | | | | | | | | AOA | PCT |
|---|---|---|---|---|---|---|---|---|---|
| | | Irganox | | | | Irganox | | earliest | earliest |
| | PE | PS8010FL | Naugard | Ultranox | Epon | MD | DHT- | failing | failing |
| Sample | 302-1 | (DLTDP) | 445 | 626 | 1002F | 1024 | 4A | time (hr) | time (hr) |
| E1 | 7 | 0.5 | 1.3 | 0.35 | 6 | 0.8 | 0.15 | 426 | >264 |
| E2 | 5 | 0.5 | 1.3 | 0.35 | 6 | 0.8 | 0.15 | 426 | 264 |
| C1 | 5 | 0.5 | 1.3 | 0.35 | 0 | 0.8 | 0.15 | 304 | 120 |
| E3 | 5 | 0 | 1.3 | 0.35 | 6 | 0.8 | 0.15 | 426 | >264 |
| C2 | 5 | 0 | 1.3 | 0 | 6 | 0.8 | 0.15 | 375 | >264 |
| C3 | 5 | 0 | 1.3 | 0.35 | 6 | 0.4 | 0.15 | 352 | 264 |
| C4 | 5 | 0 | 1.3 | 0.35 | 6 | 0.8 | 0 | 352 | 168 |
| E4 | 5 | 0 | 0 | 0.35 | 6 | 0.8 | 0.15 | 426 | >264 |

TABLE 2
Materials used

| Trade Name: | Description: | Type of Stabilizer |
|---|---|---|
| Irganox 1019 | N,N′-propane-1,3-diylbis[3-(3,5-di-tert-butyl-4- | phenolic antioxidant |
| | hydroxyphenyl)propionamide] | |
| Irganox 1098 | N,N′-hexane-1,6-diylbis[3-(3,5-di-tert-butyl-4- | phenolic antioxidant |
| | hydroxyphenyl)propanamide] | |
| Endura PE | Brominated FR(proprietary) | FR + Synergist |
| 302-1 | <70%; Sb₂O₃ <26%; PE | |
| Saytex HP- | Brominated polystyrene | FR |
| 7010G | | |
| Saytex BT-93W | 1,2-bis(tetrabromophthalimido)ethane | FR |
| Endura PE-80 | Masterbatch of 80% Sb₂O₃ in PE | Synergist for FR |
| Irganox | Didodecyl 3,3′-thiodipropionate | Thioester antioxidant |
| PS800FL | | |
| (DLTDP) | | |
| Naugard 445 | 4,4′-bis(alpha, alpha-dimethylbenzyl)diphenylamine | Arylamine antioxidant |
| Ultranox 626 (or | Bis(2,4-di-tert- | Diphosphite |
| Songnox | butylphenyl)pentaerythritol diphosphite | antioxidant |
| 6260FF) | | |
| Epon 1002F | Phenol, 4,4′-(1-methylethylidene)bis-, polymer | Epoxy compound |
| | with 2,2′-[(l-methylethylidene)bis (4,1- | |
| | phenyleneoxymethylene)]bis(oxirane) | |
| Irganox MD | bis(3,5-di-tert-butyl-4- | Metal Deactivator |
| 1024 | hydroxyhydrocinnamoyl)hydrazine | |
| DHT-4A | Aluminate (Al(OH)63-), (OC-6-11)-, magnesium | Acid scavenger |
| | carbonate hydroxide (2:6:1:4) | |

Sample E1 was further evaluated for abrasion resistance, cold bending, and 48 V hot water resistance according to ISO 6722.

Abrasion resistance test was conducted with a Taber Industries model 5750 Linear Abraser with a Scrape Abrasion Kit. The test parameters are as follows:
Diameter of needle is 0.45+0.01 mm
Frequency is 55 cycles/min
Displacement of needle is 20+1 mm
Length of the abrasion is 15.5+1 mm

A total vertical force of 7 N was applied to the test sample. The number of cycles were determined by taking four measurements at room temperature. The readings were: 753, 292, 375, and 885 cycles for E1, which passed the minimum 150 cycle requirement in ISO 6722.

Cold bending was performed on cable made with E1 at −40° C. for 4 hr. E1 had no cracks on the cable after cold bending.

For the 48V hot water resistance test, a test sample of 2.5 m length was prepared. 25 mm of insulation was removed from each end. The apparatus consists of an electrically non-conductive vessel containing an unused salt water bath with 10 g/L of NaCl in water at (85±5) ° C. for each test, a 48 V d.c. power source, a copper electrode, and a resistance measuring device. Insulation volume resistivity in the salt water bath and at the temperature was measured every week for 5 weeks according to ISO 6722. Cable made with E1 passed this test. Insulation volume resistivity remained above 10⁹ Ω·mm. No cracks were observed on the insulation.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

1-31. (canceled)

32. A copolyether-ester resin composition comprising:
a) a copolyether-ester;
b) a flame retardant;
c) a phosphorus-containing antioxidant;
d) an epoxy compound or a reaction product thereof;
e) a metal deactivator; and
f) an acid scavenger.

33. The copolyether-ester resin composition of claim 32, further comprising a phenolic antioxidant.

34. The copolyether-ester resin composition of claim 32, wherein the copolyether-ester is prepared from (i) a monomer comprising poly(tetramethylene oxide) glycol or, poly(trimethylene oxide) glycol, polypropylene oxide glycol, or any mixture thereof; (ii) a dicarboxylic acid selected from isophthalic acid, terephthalic acid, or any mixture thereof; and (iii) a diol selected from 1,4-butanediol, 1,3-propanediol, or any mixture thereof; or wherein the at least one copolyether-ester prepared from (i) a monomers comprising poly(tetramethylene oxide) glycol; (ii) terephthalic acid; and (iii) a diol selected from 1,4-butanediol, 1,3-propanediol, or any mixture thereof.

35. The copolyether-ester resin composition of claim 32, wherein the flame retardant is brominated.

36. The copolyether-ester resin composition of claim 32, comprising the flame retardant in an amount ranging from about 2% to about 20% by weight of the resin composition.

37. The copolyether-ester resin composition of claim 32, wherein the phosphorous-containing antioxidant is a phosphite or a phosphonite.

38. The copolyether-ester resin composition of claim 32, wherein the phosphorous-containing antioxidant is a diphosphite, a sterically hindered aryl phosphite, a hindered amine stabilizer phosphite, a pentaerythritol diphosphite, or any mixture thereof.

39. The copolyether-ester resin composition of claim 32, wherein the phosphorous-containing antioxidant is tris(2,4-di-tert-butylphenyl) phosphite, 1,3,7,9-tetratert-butyl-11-(2-ethylhexoxy)-5h-benzo[d][1,3,2]benzodioxaphosphocine, 3,9-bis(octadecyloxy)-2,4,8,10-tetraoxa-3,9-diphosphaspiro[5.5]undecane, bis(2,4-dicumylphenyl) pentaerythritol diphosphite, tris(nonylphenyl) phosphite, isodecyl diphenyl phosphite, 4,4′-isopropylidenediphenol C12-15 alcohol phosphite, triisodecyl phosphite, 2-ethylhexyl diphenyl phosphite, triphenyl phosphite, diisodecyl phenyl phosphite, bis(2,6-di-ter-butyl-4-methylphenyl)pentaerythritol-di-phosphite, bis(2,4-di-t-butylphenyl)pentaerythritol diphosphite, 2,2′2″-nitrilo[triethyl-tris[3,3′,5,5′-tetra-tert-butyl-1,1′-biphenyl-2,2′-diyl]] phosphite, tetrakis(2,4-di-tert-butylphenyl)[1,1-biphenyl]-4,4′diylbisphosphonite, or any mixture thereof.

40. The copolyether-ester resin composition of claim 32, wherein the phosphorous-containing antioxidant is bis(2,4-di-tert-butylphenyl)pentaerythritol diphosphite, bis(2,6-di-ter-butyl-4-methylphenyl)pentaerythritol-di-phosphite, bis (2,4-dicumylphenyl) pentaerythritol diphosphite, Bis(2,4-di-t-butylphenyl)Pentaerythritol diphosphite, or any mixture thereof.

41. The copolyether-ester resin composition of claim 32, comprising the phosphorous-containing antioxidant in an amount ranging from about 0.05% to about 2% by weight of the resin composition.

42. The copolyether-ester resin composition of claim 32, wherein the epoxy compound has two or more epoxy groups.

43. The copolyether-ester resin composition of claim 32, wherein the epoxy compound is poly(bisphenol A-co epichlorohydrin) glycidyl end-capped, poly(bisphenol F-co epichlorohydrin) glycidyl end-capped, tetraglycidyl ethers of tetraphenol ethane, polypropyleneglycol diglycidyl ether copolymers of ethylene/n-butyl acrylate/glycidyl methacrylate, copolymers of ethylene/n-methyl acrylate/glycidyl methacrylate, resorcinol diglycidyl ether, poly(phosphonate-co-carbonate, or any mixture thereof.

44. The copolyether-ester resin composition of claim 32, comprising the epoxy compound in an amount ranging from about 0.01% to about 10% by weight of the resin composition.

45. The copolyether-ester resin composition of claim 32, wherein the metal deactivator is bis(3,5-di-tert-Butyl-4-hydroxyhydrocinnamoyl)hydrazine.

46. The copolyether-ester resin composition of claim 32, comprising the metal deactivator in an amount ranging from about 0.01% to about 2% by weight of the resin composition.

47. The copolyether-ester resin composition of claim 32, comprising the acid scavenger in an amount ranging from about 0.1% to about 1% by weight of the resin composition.

48. The copolyether-ester resin composition of claim 32, which is free of thioester antioxidants.

49. A cable made from the copolyether-ester resin composition of claim 32.

50. The cable of claim 49, which is an ultrathin wall automotive cable having an outer diameter ranging from about 0.8 mm to about 1.5 mm.

51. The cable of claim 50, which has a wall thickness ranging from about 0.1 mm to about 0.5 mm.
